(19) United States
(12) Patent Application Publication
(10) Pub. No.: US 2010/0042313 A1
(43) Pub. Date: Feb. 18, 2010

(54) Phone map

(76) Inventor: Chang Goo Kang, Ossining, NY (US)

Correspondence Address: Changgoo Kang, 20 Sabrina Ln, Ossining, NY, 10562, US

(21) Appl. No.: 12/143,802

(22) Filed: Aug. 18, 2008

(51) Int. Cl. G01C 21/00

(52) U.S. Cl. 701/200

(57) ABSTRACT

The invention in this patent application is to input a telephone number (instead of an address) to search for a route in a GPS navigator system or an online or electronic map.

### BACKGROUND OF THE INVENTION

Currently, when using GPS navigator systems or online or electronic maps, the consumer needs to input a full address to get the route, which is inconvenient. In addition, if the address is typed slightly different from the map database (such as one extra space or a missing comma), the search will return no result.

### BRIEF SUMMARY OF THE INVENTION

This invention which uses a telephone number (instead of an address) to search for a route will be a new and useful improvement to GPS navigator systems and online or electronic maps.

Newness: The invention uses telephone numbers to search for routes, while the current GPS navigator systems and online or electronic maps are using addresses to search, which is very cumbersome to users.

Usefulness: First, this invention will make it much easier for consumers to input when searching for routes, because telephone numbers are in a standard format and have fewer digits to key in than addresses. Second, the invention will allow consumers to use GPS and electronic maps, even if the consumer doesn't know the exact full address (or no address at all). This will significantly improve consumer experience with GPS and electronic maps. Third, in GPS enabled cell phones or PDAs, the invention will allow consumers to choose phone numbers from their own contact list to find routes in the GPS navigator embedded cell phones. As such, consumers will not need to know and memorize the addresses to use a GPS navigator and electronic map.

### DETAILED DESCRIPTION OF THE INVENTION

The invention in this patent application is to use a telephone number (instead of an address) to search for a route in a GPS navigator system or online or electronic map.

This can be done by joining two databases into one:
1. A telephone directory which contains telephone numbers and corresponding addresses, which is currently available in telephone directory services such as Yellow Page;
2. A map database which contains the addresses and maps and routes, which is currently in all the GPS navigator systems and online/electronic maps.

The addresses are the common field (or primary key) of the two databases, so the two databases are joined into one database via addresses.

The database can be built in any database software, such as Microsoft Excel and Microsoft Access.

With this joined database, when searching for a map, the consumer only needs to input a telephone number without the address, then the GPS or electronic map will automatically search for the map and/or route in the joined database.

The invention claimed is:

1. A method for searching for a route by inputting a telephone number instead of inputting a full address in GPS navigator systems or online or electronic maps.
